(19) United States
(12) Patent Application Publication
(10) Pub. No.: US 2006/0038397 A1
(43) Pub. Date: Feb. 23, 2006

(54) Split PVC repair coupling

(76) Inventor: Elmo Barrera, Aventura, FL (US)

Correspondence Address: David W Barman, 1101 NE 176 Terrace, North Miami Beach, FL, 33162, US

(21) Appl. No.: 10/921,258

(22) Filed: Aug. 19, 2004

(51) Int. Cl. F16L 55/18

(52) U.S. Cl. 285/15

(57) ABSTRACT

An improved interlocking pipe repair coupling suitable to join together two portions of pipe, or to close a hole, comprising two interlocking couplings with the strength to withstand pressure up to 500 psi, and a method for using said improved repair coupling is described.

### FIELD OF THE INVENTION

The invention relates to pipe repair couplings; and, more particularly, to a quick and easy pair of coupling segments which can be snapped together about a pipe being repaired that is suitable to repair both punctured pipe and to join disconnected pipe segments.

### DESCRIPTION OF THE PERTINENT ART

Various types of couplings and methods have been suggested over the years. Conventional plastic pipe, such as PVC pipe, used in sprinkler systems or the like, must be repaired in situ in a quick and easily manner. Such repairs should result in a leak tight seal. Generally, such repairs may be made by unskilled homeowners who do not have sophisticated tools to make such repairs.

In U.S. Pat. No. 5,007,666 to Kyfec, semi-circular segments are used to join two pipe sections together. These segments have tongue and groove portions extending along their mating edges to interlock the same about abutting pipe sections. However, such interlock is not very positive and a clamp or vise grip pliers must be used to hold the interlocking edges together until the cement dries.

In U.S. Pat. No. 3,406,987, a pair of semi-circular sleeves are used to join ends of pipe sections together. One sleeve has channels along its elongated edges receiving therein in slidable relationship flanges along the elongated edges of the other sleeve. There is no positive interlocking of the segments and bolts are used to connect the edges. Since the two segments are not identical, they must be separately manufactured and added parts, e.g., bolts, are required.

In U.S. Pat. No. 5,443,096 describes two interlocking semicircular parts that are joined together through an interlocking closure. The patent further describes closure of the apparatus by “squeezing the segments together.” However, this patent is deficient in several areas. The orientation of the seam created by the closure is along the same radius on both the outer and the inner surface. The seam orientation prevents the closure of this invention from being suitable to withstand the pressure created by either large holes, or by joining two sections of pipe through the coupling.

There thus exists a need for a quick and easy coupling, able to withstand significant pressure, for repairing holes in plastic pipe and/or joining two sections of pipe without need for tools.

### SUMMARY OF THE INVENTION

It is an object of this invention to provide an improved coupling for repairing a hole in plastic pipe in situ.

It is a further object of this invention to provide such a coupling which comprises two semi-circular parts that can be snap fit together and interlock about a cylindrical pipe.

It is still another object of this invention to provide a pipe repair coupling that assures a strong seal without need of holding the coupling in place.

It is still another object of this invention to provide a pipe repair coupling that assures a strong seal, by creating a seam that is offset from the line where the closure is completed.

These and other objects are preferably accomplished by providing a pipe repair coupling comprising a pair of semi-circular separate and independent coupling segments, wherein the coupling segments create a closure and the inner seam is offset from the seam created on the interface of the two coupling potions on the outer surface. When coupled together along one elongated edge in a snap fit relationship, the interconnected segments may be placed about a cylindrical pipe to repair a hole or the like therein, then squeezed together to lock along the other free elongated edges thereof. The coupling of the present invention is particularly well-suited for joining two sections of discontinuous pipe to form a single passageway through the two pipes. A suitable adhesive may be applied between the coupling and the pipe being repaired prior to squeezing the segments together.

### BRIEF DESCRIPTION OF THE DRAWING

FIG. 1 is a perspective view of one coupling in accordance with the teachings of the invention;

FIG. 2 is a perspective view of a second coupling to be joined with the coupling of FIG. 1;

FIG. 3 is perspective view of the coupling around two pipe segments of FIGS. 1 and 2 illustrating how one of the coupling segments is placed about a cylindrical pipe;

FIG. 4 is perspective view of the coupling segments joined around two sections of pipe; and

FIG. 5 is a perspective view of the two coupling segments being joined to form the coupler of the invention thereto;

### DESCRIPTION OF THE PREFERRED EMBODIMENT

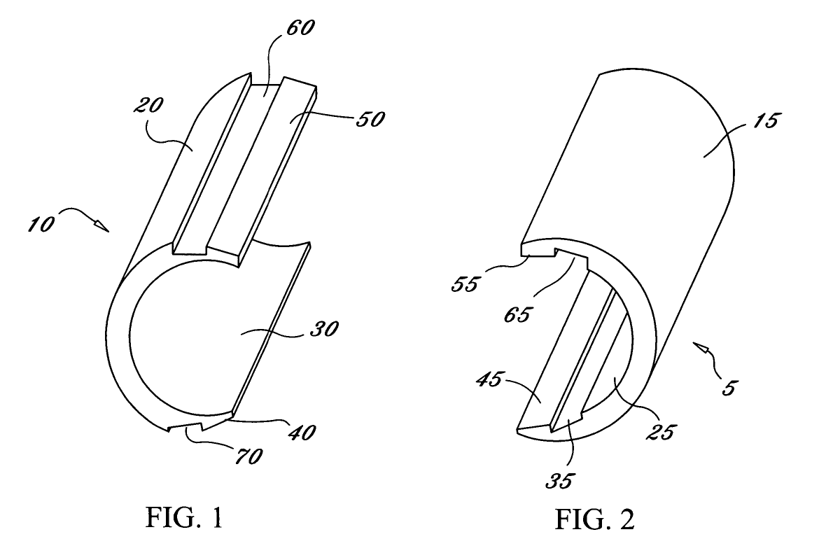

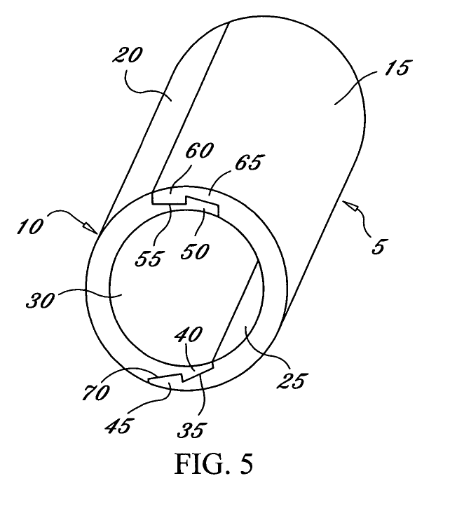

Referring now to FIG. 1 of the drawing, a coupling segment 10 in accordance with the teachings of the invention is shown. The coupling segment 10 is semicircular and has an outer surface 20 and an inner surface 30. The coupling of the invention is used by connecting segment 10 with segment 5 which are a pair of interlocking semi-circular segments which, when in the fully interlocked position (FIGS. 4 and 5), form a circular throughbore of an inner diameter generally related to the outer diameter of pipe (FIGS. 3 and 4, pipe segments 100 and 110.

FIG. 1 further shows upper female interlock channel 60 and lower female interlock channel 70. Each terminating portion of the coupling portion is on opposite ends of the semi circle. FIG. 1 shows a rectangular male interlock 50 and triangular male interlock 40. For the purposes of this invention, male interlock portion means that region which is inserted and female interlock means the region that receives the interlock.

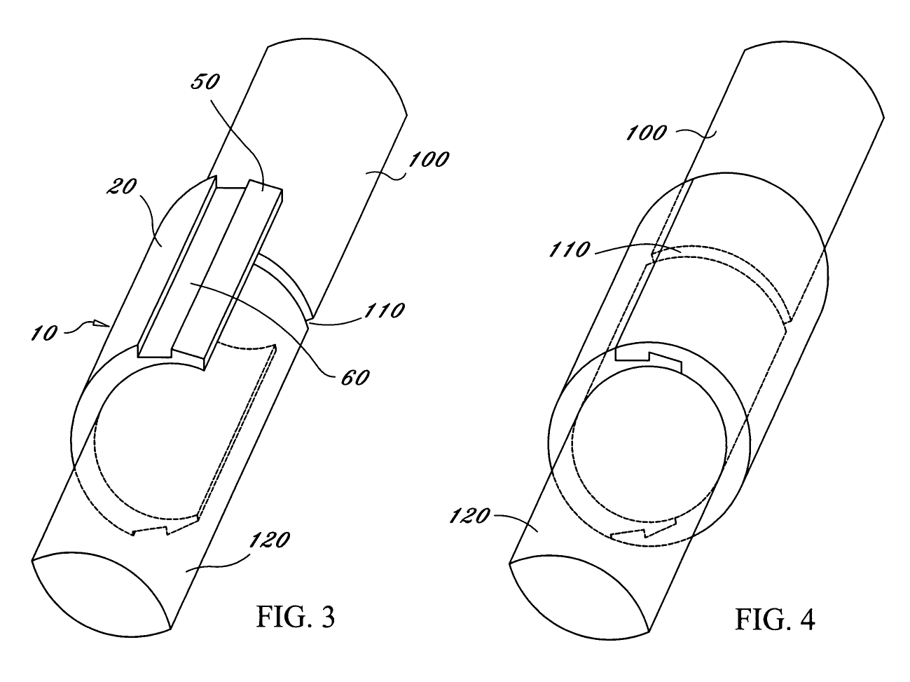

Referring now to FIG. 2 of the drawing, a coupling segment 5 in accordance with the teachings of the invention is shown. The coupling segment 5 is semicircular and has an outer surface 15 and an inner surface 25. The coupling of the invention is used by connecting segment 10 with segment 5 which are a pair of interlocking semi-circular segments which, when in the fully interlocked position (FIGS. 4 and 5), form a circular throughbore of an inner diameter generally related to the outer diameter of pipe (FIGS. 3 and 4, pipe segments 100 and 120. When using the coupling of the present invention, there may be a region 110 where the pipes do not connect.

FIG. 2 further shows upper female interlock channel 65 and lower female interlock channel 35. Each terminating portion, comprising either a male or female interlock, of the coupling portion is on opposite ends of the semi circle. FIG. 2 shows a rectangular male interlock 55 and triangular male interlock 45.

FIG. 3 shows placement of coupling segment 10 placed around two pipe segments 100 and 110.

FIG. 4 shows placement of the second coupling segment 5 joined and interlocked with coupling segment 10 and forming an enclosure around pipe segments 100 and 120. Pipe segments 100 and 120 are not connected and there is an interface 110 wherein each pipe segment 100 and 120 are in close proximity. The present invention forms a contiguous channel such that passage of matter though pipe 100 and pipe 120 may continue even though the pipe segments are not contiguous. The present invention provides a novel advantage over other couplings in that the coupling of the present invention may join two discontiguous pipes and allow the flow to continue between the two discontiguous portions. The coupling of the present invention forms a watertight seal. It further may withstand elevated pressure up to 500 psi allowing it to be used to join discontiguous portions of pipe.

The configuration of the interlock and inner seam when the two couplings are formed, provides a coupling able to withstand up to 500 pounds per square inch (psi) of pressure. The inventors have discovered that when the seam created by the interface of inner surface 25 and 30, as shown in FIG. 5, is offset from the radius created at the interface of the two outer surface portions 20 and 15, the coupling of the present invention provides a stronger coupling than those that have been previously described and sold. Other coupling devices that have claimed to be suitable for plugging holes were tested and found to be unsuitable for use in connecting discontiguous pipe sections. The offset is measured from a radius drawn from the seam formed by the interface of the outer surface 20 and 15 of each coupling portion.

As seen in FIG. 5, the coupling is joined by interlocking means. First interlocking means comprises the joining of 55 with 60 and 45 with 70. A second interlocking means comprises joining sections 50 with 65 and 40 with 35.

One embodiment of the present invention may be described as A pipe repair coupling for repairing a cylindrical pipe comprising:

a pair of interlocking semi-circular independent segments, each of said segments being adapted to interlock together and form a cylindrical throughbore conforming to the outside surface of a cylindrical pipe with no spacing between said outer surface and said throughbore. Said coupling is closed by a snap type closure comprising first and second interlocking means on each of said pair of interlocking semi circular segments. When the segments are joined there is an interface of the two segments along the outer and inner surfaces of each segment. This interface is offset such that they do not lie on the same radial line drawn from an edge to the center of the coupling. These offset interfaces provide strength for the coupling to be used for either connecting two sections of pipe or repairing a hole. The coupling of the present invention may withstand pressure up to 500 psi.

In one embodiment, each of said segments may be identical and comprise a main semi-circular elongated body portion having an inner curved surface with said body portion terminating in spaced elongated edges, one of said elongated edges having first interlocking means adapted to interlock with second interlocking means on the other of said elongated edges in snap fitting relationship whereby the first interlocking means of one of said segments may be snap fit into the second interlocking means of the other of said segments forming a longitudinal generally cylindrical throughbore therethrough, wherein said first interlocking means includes said main body portion terminating along one elongated edge in a single inwardly extending lip spaced from a ledge integral with both said main body portion at one end, said lip interconnected to said ledge by a sidewall portion at an opposite end of the ledge, said ledge extending outwardly from said main body portion in a direction opposite said lip forming a first elongated slot therebetween, and said second interlocking means includes said main body portion terminating along its other elongated edge in a single outwardly extending lip spaced from a flange extending from and integral with said main body portion in the same direction as said second mentioned lip, the spacing between said second mentioned lip and said flange forming a second elongated slot therebetween, whereby, when said first and second coupling segments are interlocked together, said first mentioned lip on one of said segments snap fits into said second elongated slot on the other of said segments and the first mentioned lip on the other of said segments snap fits into the second elongated slot on said one of said segments.

The present invention further encompasses a method for either joining two portions of pipe, or repairing a hole in a pipe segment. The method for applying an improved coupling able to withstand up to 500 psi, to join two segments of pipe, or repair a hole or crack in cylindrical pipe comprises the steps of:

cleaning said pipe around the area to be repaired until said area is clean and dry. An alternate method may comprise applying an acceptable adhesive to the two sections of pipe or the hole to be repaired.

Placing each of two coupling segments around the outer surface of the area in need of repair; and snap closing the coupling around the pipe to be repaired. After the coupling is in place, one may resume using the repaired pipe by allowing matter to flow through the repaired portion such that the matter flowing through the pipe exerts a pressure on the repair coupling up to 500 psi.

Any suitable size segments may be used dependent on the pipe outer diameter. Since the segments are made of plastic, they may be quickly and easily economically manufactured. Thus, different sized couplings, e.g., for ½″ outer diameter pipe, ¾″ outer diameter pipe, etc. may be provided. Broken polyvinyl chloride pipe, conventionally used in sprinkler systems, may be quickly and easily repaired in situ. The pipe being repaired need not be cut to remove the damaged section. Repairs may be quickly and economically made, by spreading glue over the damaged area, and snapping on the mating coupling segments.

The difficulty encountered in using previous split couplings on plastic pipe in the past was that the two coupling halves had to be held together in some way while the cement set. This required an installer having a tireless grip hold the halves together until the cement set or the use of a pipe clamp over the two halves. The interlocking feature disclosed herein holds the two parts uniformly in contact with the pipe, because the coupling is held together along its entire length. The interlocking feature of the present invention provides greater strength than previous interlocking couplings in that it may be used to join together two sections of pipe, or close a hole. The coupling of the present invention may be used in environments where pressure up to 500 psi is exerted on the coupling.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A pipe repair coupling for repairing a cylindrical pipe comprising: a pair of interlocking semi-circular independent segments, each of said segments being adapted to interlock together and form a throughbore conforming to the outside surface of a pipe with no spacing between said outer surface and said throughbore, said throghbore formed by said coupling able to withstand pressure up to 500 psi.

2. The pipe repair coupling of claim 1 wherein said throughbore is cylindrical.

3. The pipe repair coupling of claim 1 wherein said pipe is cylindrical.

4. The pipe repair coupling of claim 1 wherein each of said segments are identical.

5. The pipe repair coupling of claim 1 wherein said segments comprise at least one interlocking means.

6. The pipe repair coupling of claim 1 wherein said segments are joined and form an interface on the outer surface and an interface on the inner surface.

7. The pipe repair coupling of claim 6 wherein said outer surface interface and said inner surface interface are not along the same radius.

8. A method for joining two portions of a pipe comprising the steps of:
a. cleaning said pipe around the area to be repaired until said area is clean and dry;
b. optionally applying an acceptable adhesive to the two sections of pipe to be repaired;
c. placing each of two coupling segments around the outer surface of the area in need of repair;
d. and snap closing the coupling around the pipe to be repaired;
e. allowing matter to flow through the repaired portion such that they exert a pressure on the repair coupling up to 500 psi.

7. A method for repairing a hole in a pipe comprising the steps of:
a. cleaning said pipe around the area to be repaired until said area is clean and dry;
b. optionally applying an acceptable adhesive around the hole to be repaired;
c. placing each of two coupling segments around the outer surface of the area in need of repair;
d. and snap closing the coupling around the pipe to be repaired;
e. allowing matter to flow through the repaired portion such that they exert a pressure on the repair coupling up to 500 psi.
